(19) United States
(12) Patent Application Publication
(10) Pub. No.: US 2010/0167032 A1
(43) Pub. Date: Jul. 1, 2010

(54) FRONT ELECTRODE FOR PDP

(75) Inventor: Ji-Yeon Lee, Kanakawa-ken (KR)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I.DU PONT DE NEMOURS AND COMPANY, Wilmington, DE (US)

(21) Appl. No.: 12/638,248

(22) Filed: Dec. 15, 2009

Related U.S. Application Data
(60) Provisional application No. 61/140,298, filed on Dec. 29, 2008.

(51) Int. Cl. B32B 7/02; B05D 5/12

(52) U.S. Cl. 428/212; 427/77

(57) ABSTRACT

A PDP front electrode of this invention comprises a black layer which includes glass with a softening point not greater than 400° C.; and a white layer which includes glass with a softening point not greater than 500° C., and which is formed on the black layer.

This application is a non-provisional of U.S. Patent Application No. 61/140,298 filed on Dec. 23, 2008.

### FIELD OF THE INVENTION

This invention relates to a front electrode for Plasma display panel (PDP).

### TECHNICAL BACKGROUND OF THE INVENTION

The use of lead in the glass substrates employed in PDP front panels has recently been restricted in order to prevent environmental pollution. Bi₂O₃, B₂O₃, BaO, and alkali metal oxides are now used as alternatives to PbO capable of suitably preserving the glass substrate properties. However, during the process in which the Ag-containing electrode paste is sintered, ionized Ag reaches the glass substrate and reacts with alkali components such as sodium ions in the glass substrate, causing the glass substrate to yellow. This yellowing lowers the PDP image quality. Progress has recently been made in the development of PDP front panels which do not have the transparent electrodes normally found between the glass substrate and front electrodes, but the absence of transparent electrodes results in even greater levels of Ag ions reaching the glass substrate and thus greater yellowing. The present invention provides a front electrode which overcomes such yellowing and is capable of improving PDP panel image quality, as well as a method for its formation.

The following means for overcoming PDP yellowing have been adopted in the past.

US2007046568 discloses a non-photosensitive black layer composition using glass with a softening point of 300 to 600° C. based on lead oxide, bismuth oxide, zinc oxide, or the like for preventing yellowing.

Specifically, this includes 10 to 30 wt % black pigment, 1 to 5 wt % conductive powder, 5 to 30 wt % organic binder, 0.1 to 10 wt % plasticizer, and 30 to 50 wt % glass frit.

EP1990821 discloses a front electrode containing glass frit with a softening temperature over 550° C., comprising bismuth oxide and at least one from among molybdenum oxide, magnesium oxide, and cerium oxide, for preventing dielectric layer or glass substrate discoloration.

It is desirable to provide a front electrode capable of improving the PDP panel image quality by controlling glass substrate yellowing.

### SUMMARY OF THE INVENTION

Described herein is a PDP front electrode comprising a black layer which includes glass with a softening point not greater than 400° C.; and a white layer which includes glass with a softening point not greater than 500° C., and which is formed on the black layer. The specific gravity of the said glass included in the black layer and white layer is preferably not less than 4.0. And the black layer is preferably formed through sintering of a black paste comprising a black powder, glass frit, and photopolymerizable monomer dispersed in a mixture of a resin, photopolymerization initiator, and solvent. The white layer is preferably formed through sintering of a white paste comprising a conductive powder, glass frit, and photopolymerizable monomer dispersed in a mixture of a resin, photopolymerization initiator, and solvent. The PDP front electrode of this present invention is preferably formed on a glass substrate with no transparent electrode interposed.

The present invention also relates to a method for forming a PDP front electrode, comprising; a step of applying a black paste including a glass frit with a softening point not greater than 400° C. on a glass substrate to form a black layer; a step of drying the black paste that has been applied; a step of applying a white paste including a glass frit with a softening point not greater than 500° C. on the dried black paste to form a white layer; a step of drying the white paste that has been applied; and a step of exposing, developing, and sintering the black paste and white paste. The method for forming a PDP front electrode of this present invention is preferably formed on a glass substrate with no transparent electrode interposed.

Producing such a front electrode will control glass substrate yellowing and allow a PDP with better display quality to be realized, regardless of the existence or absence of transparent electrodes. The PDP front electrode of the present invention may be used in the case wherein the PDP front electrode is formed on a glass substrate with no transparent electrode interposed.

### BRIEF DESCRIPTION OF THE DRAWINGS

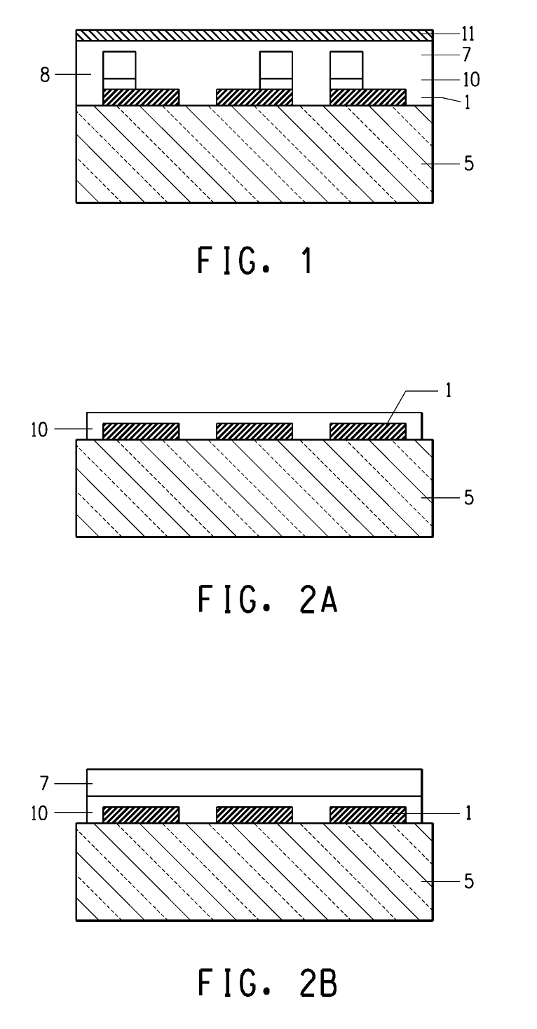

1. FIG. 1 shows the structure of an AC PDP device.

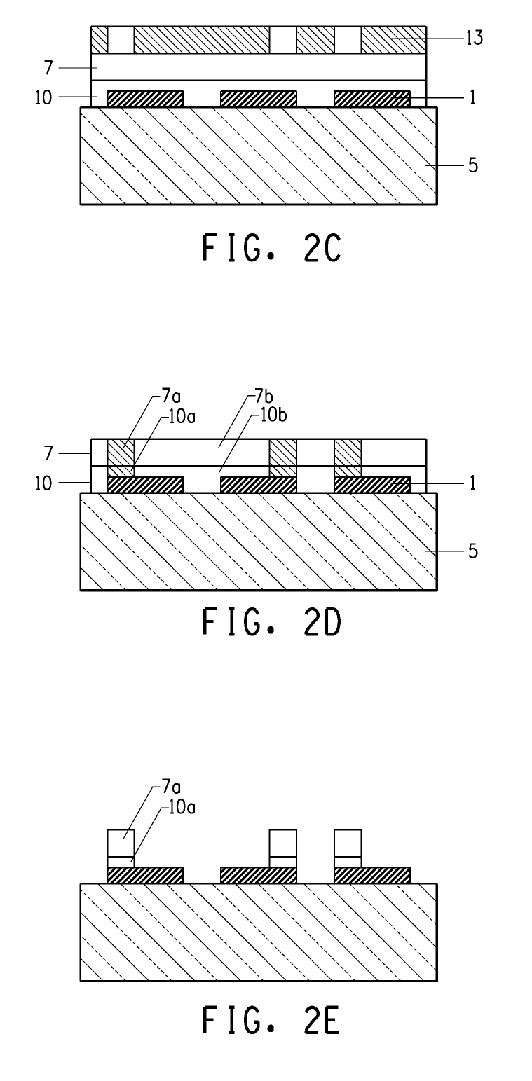

2. FIG. 2 (FIGS. 2A through 2E) shows the method for forming a first embodiment of a front electrode.

### DETAILED DESCRIPTION OF THE INVENTION

A first embodiment of the present invention relates to a front electrode for a PDP, comprising a white layer and a black layer, wherein the softening point of the glass frit included in the black layer is not more than 400° C., and the softening point of the glass frit included in the white layer is not more than 500° C. The white layer is formed by means of a white paste, and the black layer is formed by means of a black paste which is photosensitive. The materials of the pastes, methods for producing the pastes, and method for forming the front electrode are described below.

### Black Paste

The black layer of the front electrode in the present invention is preferably formed using a black paste having the composition described below in order to have the inherent function of improving the display panel contrast and the function of controlling yellowing. In addition, the term “black paste or black layer” in the present invention means an underlayer black electrode paste or electrode layer that is formed to provide contrast within the front electrode. Black can also be represented by an L value, but black means that the L value is relatively high among the layers forming the front electrode.

### (A) Glass Frit

The black paste for forming the front electrode of the present invention includes a glass frit. The basic function of the glass frit used in the present invention is to promote sintering of conductive component particles and also to bind the electrode on the substrate. The softening point of the glass frit used in the black layer in the present invention is not more than 400° C., and preferably not more than 380° C. Glass with a softening point of between 420° C. and 650° C. has primarily been used in the past. JP2004-055402 suggests avoiding the use of glass frit with a softening point under 400° C., stating that the glass frit will begin to melt before the binder resin described below is decomposed and removed in the sintering process, resulting in the risk of organic residue in the sintered pattern. However, as a result of extensive research on all compositions, the present inventors obtained a black paste composition for forming a front electrode, wherein the softening point of the glass included in the black layer of the front electrode is not more than 400° C., and the softening point of the glass included in the white layer is not more than 500° C., thereby allowing reactions between the Ag included in the front electrode and the sodium ions of the glass substrate to be controlled so as to reduce yellowing. The minimum glass softening point is not particularly limited because the lower the softening point of the glass included in the black layer and white layer, the greater the tendency for yellowing to be suppressed in the sintered glass substrate. Realistically, however, it would be difficult to obtain glass with a softening point not greater than 300° C. In this specification, “softening point” is determined by differential thermal analysis (DTA). To determine the glass softening point by DTA, sample glass is ground to a particle size of between 10 um and 100 μm, and is introduced with a reference material into a furnace to be heated at a constant rate of 5 to 10° C. per minute. The difference in temperature between the two is detected to investigate the evolution and absorption of heat from the material. Thermally stable alumina is often used as the reference material. In the present invention, the glass frit softening point is an important characteristic for ensuring good front electrode properties. Examples of glass having such a low softening point include lead based, zinc based, boron based, phosphorus based or bismuth based glass.

Oxides of these glasses include lead oxide (PbO), zinc oxide (ZnO), boron oxide (B₂O₃), phosphorus pentoxide (P₂O₅), and bismuth oxide (Bi₂O₃), and fluorides include lead fluoride (PbF₂), bismuth fluoride (BiF₃), lithium Fluoride (LiF), sodium fluoride (NaF), potassium fluoride (KF), and zinc fluoride (ZnF₂). The glass used in the present invention may be composed of oxides alone, fluorides alone, or mixtures thereof. The glass used in the present invention will preferably include one or more oxides from among lead oxide (PbO), zinc oxide (ZnO), boron oxide (B₂O₃), phosphorus oxide (P₂O₅), and bismuth oxide (Bi₂O₃). The glass will even more preferably include one or more from among ZnO, B₂O₃, Bi₂O₃, or P₂O₅. When such oxides are included, the preferred content will depend on the composition, but will preferably be as follows in the interest of achieving a low softening point. The content of PbO is preferably 20-90 wt %, more preferably 60-90 wt %. The content of ZnO is preferably 3-40 wt %, more preferably 5-30 wt % The content of B₂O₃ is preferably 3-60 wt %, more preferably 5-50 wt % The content of P₂O₅ is preferably 30-80 wt %, more preferably 35-75 wt %. The content of Bi₂O₃ is preferably 20-80 wt %, more preferably 40-60 wt %. The content of B₂O₃ is preferably 1-10 wt %, more preferably 2-4 wt %. The glass composition may also furthermore include one or more oxides from among BaO, Al₂O₃, TiO₂, K₂O, Na₂O, and Li₂O. When these oxides are included, the preferred content will be as follows. The content of BaO is preferably 0-20 wt %, more preferably 0-10 wt %. The content of Al₂O₃ is preferably 0-25 wt %, more preferably 0-15 wt %. The content of TiO₂ is preferably 0-25 wt %, more preferably 0-15 wt %. The content of K₂O is preferably 0-25 wt %, more preferably 0-15 wt %. The content of Na₂O is preferably 0-25 wt %, more preferably 0-15 wt %. The content of Li₂O is preferably 0-25 wt %, more preferably 0-15 wt %. United States patent publications US2006272700, US2006231803 and US2006231800, and EP0545166 can also be used as references to find means for obtaining glass having a low softening point (glass compositions and methods for producing glass).

In addition, the specific gravity of the glass included in the black layer of the front electrode is preferably not less than 4.0, and more preferably not less than 7.0.

The particle size of the glass frits used in the present invention preferably has D50 (i.e., the point at which ½ of the particles are smaller than and ½ are larger than the specified size) of 0.1-10 μm as measured by Microtrac. More preferably, the particle size of the glass frits has D50 of 0.5 to 2 μm. Usually, in an industrially desirable process, glass frit is prepared by the mixing and melting of raw materials such as oxides, hydroxides, carbonates, etc., making into a cullet by quenching, mechanical pulverization (wet, dry), then drying in the case of wet pulverization. Thereafter, if needed, classification is carried out to the desired size. It is desirable for the glass frit used in the present invention to have an average particle diameter smaller than the thickness of the black conductive layer to be formed.

Based on the total weight of the conductive paste, the glass frit content is preferably 20-45 wt %, more preferably 28-40 wt %. When the glass frit content is too small, bonding to the substrate is weak. On the other hand, when the glass frit content is too large, conductivity gets low.

### (B) Black Pigment

Black pigment is used to ensure the blackness of the black front electrode.

The black pigment of the black paste in the present invention is not particularly limited. Examples include CO₃O₄, chromium-copper-cobalt oxides, chromium-copper-manganese oxides, chromium-iron-cobalt oxides, ruthenium oxides, ruthenium pyrochlore, lanthanum oxides (ex. La₁₋ₓSrₓCoO₃), manganese cobalt oxides, and vanadium oxides (ex. V₂O₃, V₂O₄, V₂O₅). CO₃O₄ (tricobalt tetroxide) is preferred in consideration of the burden imposed on the environment, material costs, the degree of blackness, and the electrical properties of the black layer. The black pigment content is preferred to be 6 to 20 wt %, and preferably 9 to 16 wt %, based on the total weight of the black paste.

### (C) Conductive Powder

A conductive powder may be added to the black paste to ensure that the black layer is conductive with the white layer and transparent electrode in case of transparent electrode is formed. Because the black pigment described in section (B) is conductive to a certain extent, the content of the conductive powder in the black paste will depend on the black pigment conductivity and amount added. For example, when a black pigment having a certain degree of conductivity such as ruthenium oxide or ruthenium pyrochlore is used, no conductive power will need to be added. In consideration of the above, the content of the conductive powder in the black paste is preferably as follows. The content of the conductive powder is, preferably 0.01-3.0 wt %, more preferably 0.1-1.0 wt % based on the total weight of the black paste. Conductive metal powder gives conductivity to a pattern formed from the black paste. Such conductive powder includes, but is not limited to, gold (Au), silver (Ag), platinum (Pt), palladium (Pd), copper (Cu), aluminum (Al), nickel (Ni), tungsten (W), a combination thereof or an alloy thereof. In terms of conductivity, the conductive powder is preferably Au, Pt, Ag, Pd, a combination thereof or an alloy thereof. In terms of cost and effect, the conductive powder is preferably Cu, Ni, Al, W, a combination thereof or an alloy thereof. The alloy includes, but not limited to, Ag—Pd alloy, Ag—Pt alloy, Ag—Pt—Pd alloy, Pt—Pd alloy. In terms of cost and effect, the alloy is preferably Ag—Pd alloy, Ag—Pt—Pd alloy or Pt—Pd alloy, and more preferably Ag—Pd alloy. Core-shell type powder can be used as well. Examples of the core-shell powder include Cu, Ni, Al and W coated with Ag or Au. The preferred metal powders are selected from the group consisting of Au, Ag, Pd, Pt, Cu and combinations thereof. The most preferred metal powder is Ag. Ag is commonly available and inexpensive. The sintering temperature for Ag is relatively low compared with other metal like gold. Furthermore, it is possible to sinter Ag under the oxygen-containing atmosphere such as air condition.

Virtually any shape conductive powder, including spherical particles and flakes (rods, cones, and plates) may be used in the black paste. The preferred shape is a spherical shape because spherical powders have relatively better filling ratio and UV permeability than other shapes.

The conductive powders have an average particle diameter (PSD D50) ranging from 0.1 to 10.0 μm. When the average particle diameter (PSD D50) is greater than 10.0 micrometer, the number of defects in the pattern tends to increase. When the average particle diameter (PSD D50) is less than 0.1 micrometer, dispersion and exposure sensitivity of the paste tends to be poor. Here, the mean particle diameter (PSD D50) means the particle diameter corresponding to 50% of the integrated value of the number of particles when the particle size distribution is prepared. The particle size distribution can be prepared using a commercially available measuring device such as the X100 by Microtrac.

The conductive powders have a specific surface area ranging from 0.3 to 2 m²/g. Within the above range, rectilinear path of a burned film pattern tends to be excellent and dispersion and exposure sensitivity of the paste also tend to be excellent.

In addition, when the PDP front panel has no transparent electrode, that is, when the black layer is formed directly on the glass substrate, there will be no need to include a conductive powder in the black paste.

### (D) Organic Binder

An organic binder is used to allow constituents such as the conductive powder, glass powder, and black pigment to be dispersed in the composition. The organic binder is however burned off during firing process.

When the composition of the invention is used to produce a photosensitive composition, the development in an aqueous system is preferred to be taken into consideration in selecting the organic binder. One with high resolution is preferred to be selected.

Examples of organic binders include copolymers or interpolymers prepared from (1) non-acidic comonomers containing C₁ to C₁₀ alkyl acrylates, C₁ to C₁₀ alkyl methacrylates, styrene, substituted styrene, or combinations thereof, and (2) acidic comonomers containing ethylenic unsaturated carboxylic acid-containing components. When acidic comonomers are present in the conductive paste, the acidic functional groups will permit development in aqueous bases such as 0.1-0.8% sodium carbonate aqueous solution. The acidic comonomer content is preferred to be 15 to 30 wt %, based on the polymer weight.

A lower amount of acidic comonomer may complicate the development of the applied conductive paste on account of aqueous bases while too much acidic comonomer may reduce stability of the paste under a development condition, thereby resulting in only partial development in the areas where images are to be formed.

Suitable acidic comonomers include (1) ethylenic unsaturated monocarboxylic acids such as acrylic acid, methacrylic acid, or crotonic acid; (2) ethylenic unsaturated dicarboxylic acids such as fumaric acid, itaconic acid, citraconic acid, vinylsuccinic acid, and maleic acid; (3) hemiesters of (1) and (2); and (4) anhydrides of (1) and (2). Two or more kinds of acidic comonomers may be used concurrently. Methacrylic polymers are more desirable than acrylic polymers in consideration of the combustibility in low-oxygen atmospheres.

When the non-acidic comonomer is an alkyl acrylate or alkyl methacrylate noted above, the non-acidic comonomer is preferred to be 70 to 75 wt %, based on the polymer weight. When the non-acidic comonomer is styrene or substituted styrene, the non-acidic comonomer is preferred to account for about 50 wt %, based on the polymer weight, and the remaining 50 wt % is preferred to be an acid anhydride such as a hemiester of maleic anhydride. α-methylstyrene is a preferred substituted styrene.

The organic binder can be produced using techniques that are well known in the field of polymers. For example, an acidic comonomer can be mixed with one or more copolymerizable non-acidic comonomers in an organic solvent having a relatively low boiling point (75 to 150° C.) to obtain a 10 to 60% monomer mixture. Polymerization is then brought about by adding a polymerization catalyst to the resulting monomer. The resulting mixture is heated to the reflux temperature of the solvent. When the polymer reaction is substantially completed, the resulting polymer solution is cooled to room temperature to recover a sample.

The molecular weight of the organic binder is not particularly limited, but is preferably less than 50,000, more preferably less than 25,000, and even more preferably less than 15,000.

The organic binder content is preferred to be 5 to 25 wt %, based on the total amount of the composition.

### (E) Organic Solvent

The primary purpose for using an organic solvent is to allow the dispersion of solids contained in the composition to be readily applied to the substrate. As such, the organic solvent is preferred to first of all be one that allows the solids to be dispersed while maintaining suitable stability. Secondly, the rheological properties of the organic solvent are preferred to endow the dispersion with favorable application properties.

The organic solvent may be a single component or a mixture of organic solvents. The organic solvent that is selected is preferred to be one in which the polymer and other organic components can be completely dissolved. The organic solvent that is selected is preferred to be inert to the other ingredients in the composition. The organic solvent is preferred to have sufficiently high volatility, and is preferred to be able to evaporate off from the dispersion even when applied at a relatively low temperature in the atmosphere. The solvent is preferred not to be so volatile that the paste on the screen will rapidly dry at ordinary temperature during the printing process.

The boiling point of the organic solvent at ordinary pressure is preferred to be no more than 300° C., and preferably no more than 250° C.

Specific examples of organic solvents include aliphatic alcohols and esters of those alcohols such as acetate esters or propionate esters; terpenes such as turpentine, α- or β-terpineol, or mixtures thereof; ethylene glycol or esters of ethylene glycol such as ethylene glycol monobutyl ether or butyl cellosolve acetate; butyl carbitol or esters of carbitol such as butyl carbitol acetate and carbitol acetate; and Texanol (2,2,4-trimethyl-1,3-pentanediol monoisobutyrate).

The organic solvent content is preferred to be 10 to 40 wt %, based on the total amount of the composition.

### (F) Photopolymerization Initiator

Desirable photoinitiators will be thermally inactive but produce free radicals when exposed to actinic rays at a temperature of 185° C. or below. Examples include compounds having two intramolecular rings in a conjugated carbocyclic system. More specific examples of desirable photoinitiators include 9,10-anthraquinone, 2-methyl anthraquinone, 2-ethyl anthraquinone, 2-t-butyl anthraquinone, octamethyl anthraquinone, 1,4-naphthoquinone, 9,10-phenanthrenequinone, benzo[a]anthracene-7,12-dione, 2,3-naphthacene-5,12-dione, 2-methyl-1,4-naphthoquinone, 1,4-dimethyl anthraquinone, 2,3-dimethyl anthraquinone, 2-phenyl anthraquinone, 2,3-diphenyl anthraquinone, retenquinone, 7,8,9,10-tetrahydronaphthacene-5,12-dione, and 1,2,3,4-tetrahydrobenzo[a]anthracene-7,12-dione.

Other compounds that may be used include those given in U.S. Pat. Nos. 2,850,445, 2,875,047, 3,074,974, 3,097,097, 3,145,104, 3,427,161, 3,479,185, 3,549,367, and 4,162,162.

The photoinitiator content is preferred to be 0.02 to 16 wt %, based on the total amount of the composition.

### (G) Photopolymerizable Monomer

Photopolymerizable monomers are not particularly limited. Examples include ethylenic unsaturated compounds having at least one polymerizable ethylene group. Such compounds can initiate polymer formation through the presence of free radicals, bringing about chain extension and addition polymerization. The monomer compounds are non-gaseous; that is, they have a boiling point higher than 100° C. and have the effect of making the organic binder plastic. Desirable monomers that can be used alone or in combination with other monomers include t-butyl (meth)acrylate, 1,5-pentanediole di(meth)acrylate, N,N-dimethylaminoethyl (meth)acrylate, ethylene glycol di(meth)acrylate, 1,4-butanediol di(meth)acrylate, diethylene glycol di(meth)acrylate, hexamethylene glycol di(meth)acrylate, 1,3-propanediol di(meth)acrylate, decamethylene glycol di(meth)acrylate, 1,4-cyclohexanediol di(meth)acrylate, 2,2-dimethylol propane di(meth)acrylate, glycerol di(meth)acrylate, tripropylene glycol di(meth)acrylate, glycerol tri(meth)acrylate, trimethylol propane tri(meth)acrylate, the compounds given in U.S. Pat. No. 3,380,381, the compounds disclosed in U.S. Pat. Nos. 5,032,490, 2,2-di(p-hydroxyphenyl)-propane di(meth)acrylate, pentaerythritol tetra(meth)acrylate, triethylene glycol diacrylate, polyoxyethyl-1,2-di-(p-hydroxyethyl)propane dimethacrylate, bisphenol A di-[3-(meth)acryloxy-2-hydroxypropyl)ether, bisphenol A di-[2-(meth)acryloxyethyl)ether, 1,4-butanediol di-(3-methacryloxy-2-hydroxypropyl)ether, triethylene glycol dimethacrylate, polyoxypropyl trimethylol propane triacrylate, trimethylol propane ethoxy triacrylate, butylene glycol di(meth)acrylate, 1,2,4-butanediol tri(meth)acrylate, 2,2,4-trimethyl-1,3-pentanediol di(meth)acrylate, 1-phenylethylene-1,2-dimethacrylate, diallyl fumarate, styrene, 1,4-benzenediol dimethacrylate, 1,4-diisopropenyl benzene, 1,3,5-triisopropenyl benzene, monohydroxypolycaprolactone monoacrylate, polyethylene glycol diacrylate, and polyethylene glycol dimethacrylate. Here, “(meth)acrylate” is an abbreviation indicating both acrylate and methacrylate. The above monomers may undergo modification such as polyoxyethylation or ethylation. The content of the photopolymerizable monomer is preferred to be 2 to 20 wt %.

### (H) Additional Components

The paste may also include well-known additional components such as dispersants, stabilizers, plasticizers, stripping agents, surfactants, defoamers, and wetting agents.

### White Paste

The white layer of the front electrode in the present invention is preferably formed using a white paste having the composition described below in order to have the inherent function of improving the conductivity and the function of controlling yellowing. The material for the white paste of the present invention includes conductive powder, glass frit, organic binder, organic solvent, photopolymerization initiator, photopolymerizable monomer, and additional components. As the organic binder, organic solvent, photopolymerization initiator, and photopolymerizable monomer are the same as the composition in the black paste described above, the conductive powder, glass frit, and additional components which constitute the composition specific to the white paste in the present invention will be described here. In addition, the “white paste or white layer” in the present invention means the upper layer of conductive paste or electrode layer that is formed to enhance the conductivity within the front electrode. Furthermore, white does not mean white reflecting all light, but means relatively white in relation to the black paste and black layer described above. The white layer generally includes Ag as a conductive powder, and is often perceived as white in terms of color vision because it is formed on the black layer.

### (I) Conductive Powder

Conductive powder in the white paste gives sufficient conductivity to a front electrode. Such conductive powder includes, but is not limited to, gold (Au), silver (Ag), platinum (Pt), palladium (Pd), copper (Cu), aluminum (Al), nickel (Ni), tungsten (W), a combination thereof or an alloy thereof. In terms of conductivity, the conductive powder is preferably Au, Pt, Ag, Pd, a combination thereof or an alloy thereof. In terms of cost and effect, the conductive powder is preferably Cu, Ni, Al, W, a combination thereof or an alloy thereof. The alloy includes, but not limited to, Ag—Pd alloy, Ag—Pt alloy, Ag—Pt—Pd alloy, Pt—Pd alloy. In terms of cost and effect, the alloy is preferably Ag—Pd alloy, Ag—Pt—Pd alloy or Pt—Pd alloy, and more preferably Ag—Pd alloy. Core-shell type powder can be used as well. Examples of the core-shell powder include Cu, Ni, Al and W coated with Ag or Au. The preferred metal powders are selected from the group consisting of Au, Ag, Pd, Pt, Cu and combinations thereof. The most preferred metal powder is Ag. Ag is commonly available and inexpensive. The sintering temperature for Ag is relatively low compared with other metal like gold. Furthermore, it is possible to sinter Ag under the oxygen-containing atmosphere such as air condition. The content of the conductive powder in the white paste is, preferably 0.01-3.0 wt %, more preferably 0.1-1.0 wt % based on the total weight of the black paste.

Virtually any shape conductive powder, including spherical particles and flakes (rods, cones, and plates) may be used in the black paste. The preferred shape is spherical shape because spherical powders have relatively better filling ratio and UV permeability than other shapes. When particles of this small size are present, it is difficult to adequately obtain complete burnout of the organic medium when the films or layers thereof are fired to remove the organic medium and to effect sintering of the inorganic binder and the metal solids. When the dispersions are used to make thick film pastes, which are usually applied by screen printing, the maximum particle size should not exceed the thickness of the screen. The conductive powders have an average particle diameter (PSD D50) ranging from 0.1 to 10.0 μm. When the average particle diameter (PSD D50) is greater than 10.0 μm, the number of defects in the pattern tends to increase. When the average particle diameter (PSD D50) is less than 0.1 μm, dispersion and exposure sensitivity of the paste tends to be poor. Here, the mean particle diameter (PSD D50) means the particle diameter corresponding to 50% of the integrated value of the number of particles when the particle size distribution is prepared. The particle size distribution can be prepared using a commercially available measuring device such as the X100 by Microtrac. The conductive powders have a specific surface area ranging from 0.3 to 2 m²/g. Within the above range, rectilinear path of a burned film pattern tends to be excellent and dispersion and exposure sensitivity of the paste also tend to be excellent.

### (J) Glass Frit

The white paste for forming the front electrode of the present invention includes a glass frit having a softening point of not greater than 500° C. The paste will preferably include a glass frit with a softening point not greater than 450° C., and more preferably not greater than 400° C. Glass with a softening point of 500° C. or more that is included in the white layer in the Examples below will result in glass substrate yellowing outside the permissible range.

In this specification, “softening point” is determined by differential thermal analysis (DTA) as well as the description above. In the present invention, the glass frit softening point is an important characteristic for ensuring good front electrode properties. Examples of glass having such a low softening point include lead based, zinc based, boron based, phosphorus based or bismuth based glass. Oxides of these glasses include lead oxide (PbO), zinc oxide (ZnO), boron oxide (B2O3), phosphorus pentoxide (P2O5), and bismuth oxide (Bi2O3), and fluorides include lead fluoride (PbF₂), bismuth fluoride (BiF₃), lithium Fluoride (LiF), sodium fluoride (NaF), potassium fluoride (KF), and zinc fluoride (ZnF₂). The glass used in the present invention may be composed of oxides alone, fluorides alone, or mixtures thereof. The glass used in the present invention will preferably include one or more oxides from among lead oxide (PbO), zinc oxide (ZnO), boron oxide (B2O3), phosphorus oxide (P2O5), and bismuth oxide (Bi2O3). The glass will even more preferably include one or more from among ZnO, B2O3, Bi2O3, or P2O5. When such oxides are included, the preferred content will depend on the composition, but will preferably be as follows in the interest of achieving a low softening point. The content of PbO is preferably 20-90 wt %, more preferably 60-90 wt %. The content of ZnO is preferably 3-40 wt %, more preferably 5-30 wt % The content of B2O3 is preferably 3-60 wt %, more preferably 5-50 wt % The content of P2O5 is preferably 30-80 wt %, more preferably 35-75 wt %. The content of Bi2O3 is preferably 20-80 wt %, more preferably 40-60 wt %. The content of B2O3 is preferably 1-10 wt %, more preferably 2-4 wt %. The glass composition may also furthermore include one or more oxides from among BaO, Al2O3, TiO2, K2O, Na2O, and Li2O. When these oxides are included, the preferred content will be as follows. The content of BaO is preferably 0-20 wt %, more preferably 0-10 wt %. The content of Al2O3 is preferably 0-25 wt %, more preferably 0-15 wt %. The content of TiO2 is preferably 0-25 wt %, more preferably 0-15 wt %. The content of K2O is preferably 0-25 wt %, more preferably 0-15 wt %. The content of Na2O is preferably 0-25 wt %, more preferably 0-15 wt %. The content of Li2O is preferably 0-25 wt %, more preferably 0-15 wt %. US2006272700, US2006231803, US2006231800, and EP0545166 can also be used as reference to find means for obtaining glass having a low softening point (glass compositions and methods for producing glass).

In addition, the specific gravity of the glass included in the white layer of the front electrode is preferably not less than 4.0, and more preferably not less than 7.0.

The particle size of the glass frits used in the present invention preferably has D50 (i.e., the point at which ½ of the particles are smaller than and ½ are larger than the specified size) of 0.1-10 μm as measured by Microtrac. More preferably, the particle size of the glass frits has D50 of 0.5 to 2 μm. Usually, in an industrially desirable process, glass frit is prepared by the mixing and melting of raw materials such as oxides, hydroxides, carbonates, etc., making into a cullet by quenching, mechanical pulverization (wet, dry), then drying in the case of wet pulverization. Thereafter, if needed, classification is carried out to the desired size. It is desirable for the glass frit used in the present invention to have an average particle diameter smaller than the thickness of the black conductive layer to be formed.

Based on the total weight of the conductive paste, the glass frit content should be 0.5-5.0 wt %. When the glass frit content is too small, bonding to the substrate is weak. On the other hand, when the glass frit content is too large, conductivity gets low.

### (K) Additional Components

The paste may also include well-known additional components such as dispersants, stabilizers, plasticizers, stripping agents, surfactants, defoamers, and wetting agents.

### Conductive Pastes Preparation

Methods for preparing a black paste and white paste using the compositions given above will be described below. The preparation of the pastes used in the present invention follow the common methods below. Typically, a thick film composition is blended in such a way as to have a paste-like consistency, which is referred to as a “paste.” In general, a paste involves mixing an organic binder, organic solvent, and photopolymerization initiator in a vessel under yellow light. Inorganic materials are then added to the mixture of organic components. For the black paste, inorganic materials include the glass frit, black pigment, photopolymerizable monomer, and a conductive powder, if needed. For the white paste, inorganic materials include the glass frit, photopolymerizable monomer, and conductive powder. Additives are optionally added. The composition as a whole is then mixed until the inorganic powder is dispersed to homogeneity in the organic material. The mixture is then subjected to a roll milling treatment in a three-roll mill. The viscosity of the paste at that point in time can be adjusted with a suitable vehicle or solvent so as to bring about the ideal viscosity for the treatment.

### Forming a Front Electrode

A second aspect of the present invention relates to method for manufacturing a pattern of electric device. The method for forming a pattern using the photosensitive black paste and white paste includes the steps of applying, drying, exposing, developing, and sintering the paste. A method for producing a front electrode using the black paste and white paste will be described below with reference to FIGS. 1 and 2.

FIG. 1 illustrates the structure of an AC PDP device with front electrodes having a two-layer structure. As illustrated in FIG. 1, the front panel of the AC PDP has the following structural elements: glass substrate 5, transparent electrodes 1 formed on the glass substrate 5, black layer 10 formed on the transparent electrodes 1, and white layer 7 formed on the black layer 10. A dielectric coating layer (transparent overglaze layer) (TOG) 8 and an MgO coating layer 11 are generally formed on the white layer 7. The conductive composition of the invention is used to produce the black layer 10. In recent development, however, attempts have been made to omit transparent electrodes in the interest of reducing costs.

A method for producing the front electrodes on the front panel of the PDP is described in detail below. As illustrated in FIG. 2, the method for forming the first embodiment of the front electrode of the invention comprises a series of processes (FIGS. 2A through 2E). The transparent electrodes 1 are formed on the glass substrate 5 in accordance with conventional methods known to those having ordinary skill in the art. The transparent electrodes 1 are usually formed with SnO₂ or ITO. They can be formed by ion sputtering, ion plating, chemical vapor deposition, or an electrode position technique. Such transparent electrode structures and forming methods are well known in the field of AC PDP technology. The transparent electrode has been, however, tried to be omitted in the recent development in cost reduction point of view. The present invention is suitable to this transparent less front panel.

The conductive composition for black layer in the invention is then used to apply a black paste layer 10, and the black paste layer 10 is then dried in nitrogen or the air (FIG. 2A).

A photosensitive thick film conductor paste 7 for forming the white layer is then applied on the black paste layer 10. The white paste layer 7 is then dried in nitrogen or the air (FIG. 2B).

The black paste layer 10 and white paste layer 7 are exposed to light under conditions ensuring the formation of the proper electrode patterns after development. During the exposure to light, the material is usually exposed to UV rays through a target 13 or photo tool having a configuration corresponding to the pattern of the black layer and white layer (FIG. 2C).

The parts (10a, 7a) of the black paste layer 10 and white paste layer 7 that have been exposed to light are developed in a basic aqueous solution such as 0.4 wt % sodium carbonate aqueous solutions or another alkaline aqueous solution. In this process, the parts (10b, 7b) of the layers 10 and 7 that have not been exposed to light are removed. The parts 10a and 7a that have been exposed to light remain (FIG. 2D). The patterns after development are then formed.

The material that has been formed is sintered at a temperature of between 450 and 650° C. (FIG. 2E). The sintering temperature is selected according to the substrate material. At this stage, the glass powder melts and becomes firmly attached to the substrate. As noted above, the reason is to ensure vertical conduction in PDP black layer.

The present invention is also suitable for such transparent electrode-free front panels. That is because, in the present invention, the composition included in the electrode is adjusted to reduce yellowing that result from the diffusion of Ag ions in the electrode into the glass substrate during the sintering process, even in the absence of transparent electrodes. So, although illustrated in FIG. 1 and FIG. 2, the transparent electrodes 1 are not necessary.

### EXAMPLES

The invention is illustrated in further detail below by examples. The examples are for illustrative purposes only, and are not intended to limit the invention.

### 1. Preparation of Organic Medium

15.1 wt % of Texanol (2,2,4-trimethyl-1,3-pentanediol monoisobutyrate) as the organic solvent and 7.0 wt % of acrylic polymer having a molecular weight of 6,000 to 7,000 as the organic binder were mixed, and the mixture was heated to 100° C. while stirred. The mixture was heated and stirred until all of the organic binder had dissolved. The resulting solution was cooled to 75° C. 0.35 wt % of Ethyl 4-dimethyl aminobenzoate (EDAB), 0.35 wt % of diethylthioxanthone (DETX) and 0.7 wt % of Irgacure 907 by Chiba Specialty Chemicals were added as photoinitiators, and 0.1 wt % of 1,4,4-trimethyl-2,3-diazabicyclo[3.2.2]-non-2-ene-N,N-dixoide (TAOBN) were added as additives. The mixture was stirred at 75° C. until all the solids had dissolved. The solution was filtered through a 40 micron filter and cooled.

### 2. Preparation of Black Paste

Photopolymerizable monomer, Glass frit, black pigment, conductive powder and additives were dispersed in the organic medium. The each content were 7.3 wt % of Dipentaerythritol pentaacrylate, 3.5 wt % of Ethoxytriacrylated trimethylolprpane triacrylate and 4.0 wt % of Polyether acrylate as Photopolymerizable monomer, 25.57 wt % of B2O3 based glass frit, 12.55 wt % of cobalt oxide (CO₃O₄), 0.1 wt % of Ag/Pd alloy powder, 0.4 wt % of malonic acid as a stabilizer, 0.18 wt % of butyrated hydroxytoluene ionol as an additive and 46.4 wt % of organic medium. Three kinds of glass frit with different Ts as shown in the table 1 were used.

The entire paste was mixed until the particles of the inorganic material were wet with the organic material. The mixture was dispersed using a 3-roll mill.

### 3. Preparation of White Paste

Photopolymerizable monomer, Glass frit, conductive powder and additives were dispersed in the organic medium. The each content were 2.2 wt % of Dipentaerythritol pentaacrylate and 4.16 wt % of Ethoxytriacrylated trimethylolprpane triacrylate 1.36 wt % of polyester diol diacrylate as photopolymerizable monomer, 1.0 wt % of B2O3 based glass frit, 66.5 wt % of Ag powder which had spherical shape, 0.23 wt % of malonic acid as a stabilizer, 0.05 wt % of methylalkyl polysiloxane as surfactant and 0.1 wt % of butyrated hydroxytoluene ionol as an additive and 22.8 wt % of organic medium. Three kinds of glass frit with different Ts as shown in the table 1 were used. The components described above other than glass frit and Ag powder was mixed under yellow light, so as to prepare a paste. Glass frit and Ag powder were added as the inorganic materials to the mixture of organic components. The entire paste was mixed until the particles of the inorganic material were wet with the organic material. The mixture was dispersed using a 3-roll mill.

### 4. Preparation of Front Electrodes

Precautions were taken to avoid dirt contamination, by dirt during the preparation of the paste and the manufacture of the parts would have resulted in defects.

### 4-1: Formation of Black Layer

The black paste was applied to a glass substrate (50 mm width, 75 mm length and 1.8 mm thickness) by screen printing using a 380 mesh screen. The printing pattern of the black layer was 40 mm square and 5 μm thickness. Suitable screen and viscosity of the black paste was selected, to ensure the desired film thickness was obtained. The paste was printed on the glass substrate on which transparent electrodes had been unformed. The printed black paste was then dried for 20 minutes at 100° C. in a hot air circulating furnace.

4-2: Formation of White layer

The white paste was applied by screen printing over the black layer using a 400 mesh screen. The printing pattern of the white layer was 40 mm square and 9.5 μm thickness in average. The printed white paste was dried for 20 minutes at 100° C.

### 4-3: UV Ray Pattern Exposure

The double-layered structure was exposed to light through a photo tool using a collimated UV radiation source (illumination: 18 to 20 mW/cm²; exposure: 200 mj/cm²).

### 4-4: Development

An exposed sample was placed on a conveyor and then placed in a spray developing device filled with 0.4 wt % sodium carbonate aqueous solution as the developer. The developer was kept at a temperature of 30° C., and was sprayed at 10 to 20 psi. The sample was developed for 15 seconds. The developed sample was dried by blowing off the excess water with an air jet.

### 4-5: Sintering

A peak temperature of 590° C. was reached (first sintering) by sintering in a belt furnace in air using a 1.5 hour profile. A front electrode was formed through the above steps.

### 5. Evaluation

5-1: sample preparation

A glass substrate on which the front electrode had been formed was immersed for about 2 min in 4% nitric acid liquid to separate the electrode from the glass substrate. The yellow value (b value) of the glass substrate was measured (Table 1). Measurement involves the use of a Colorimetric (SE2000, Nippon Denshoku Co., Ltd.). The light reflection angle was 90 degrees during measurement. The higher the b value in Table 1, the greater the extent of yellowing.

The results are given below, where the permissible b value is 8.5. The b value was at or under the permissible level when the Ts of the glass contained in the black layer was 380° C. and the Ts of the glass in the white layer was no more than 440° C.

TABLE 1

| | Black layer | White layer | |
|---|---|---|---|
| | glass Ts | glass Ts | b value |
| Example 1 | 380° C. | 358° C. | 8.1 |
| Example 2 | 380° C. | 380° C. | 6.8 |
| Example 3 | 380° C. | 440° C. | 8.3 |
| Comparison 1 | 380° C. | 600° C. | 9.5 |
| Comparison 2 | 440° C. | 358° C. | 9.4 |
| Comparison 3 | 440° C. | 380° C. | 9.0 |
| Comparison 4 | 440° C. | 440° C. | 11.0 |
| Comparison 5 | 440° C. | 600° C. | 12.2 |
| Comparison 6 | 450° C. | 358° C. | 10.0 |
| Comparison 7 | 450° C. | 380° C. | 10.9 |
| Comparison 8 | 450° C. | 440° C. | 12.2 |
| Comparison 9 | 450° C. | 600° C. | 14.6 |

The b value of the glass substrate was then studied using front electrodes in which the white layer contained glass with different specific gravity values. The Ts of the glass frit in the black layer and white layer was 380° C. In Example 4, Si based glass was used, and the glass included in the white layer had a specific gravity of 4.3. In Example 5, Zn based glass was used, and the glass included in the white layer had a specific gravity of 7.6. The results are given in Table 2, showing that the b value was lower in Example 5, where the specific gravity of the glass included in the white layer was greater. Thus, the greater the specific gravity of the glass frit included in the white layer, the more the glass substrate yellowing was controlled.

TABLE 2

| | Specific gravity of | Specific gravity of | |
|---|---|---|---|
| | black layer glass | white layer glass | b value |
| Example 4 | 7.6 | 4.3 | 8.3 |
| Example 5 | 7.6 | 7.6 | 6.8 |

What we claim is:

1. A PDP front electrode, comprising:
a black layer which includes glass with a softening point not greater than 400° C.; and
a white layer which includes glass with a softening point not greater than 500° C., and which is formed on the black layer.

2. The PDP front electrode according to claim 1, wherein the specific gravity of the glass included in the black layer and white layer is not less than 4.0.

3. The PDP front electrode according to claim 1, wherein the black layer is formed through sintering of a black paste comprising a black powder, glass frit, and photopolymerizable monomer dispersed in a mixture of a resin, photopolymerization initiator, and solvent.

4. The PDP front electrode according to claim 1, wherein the white layer is formed through sintering of a white paste comprising a conductive powder, glass frit, and photopolymerizable monomer dispersed in a mixture of a resin, photopolymerization initiator, and solvent.

5. The PDP front electrode according to claim 1, wherein the PDP front electrode is formed on a glass substrate with no transparent electrode interposed.

6. A method for forming a PDP front electrode, comprising:
a step of applying a black paste including a glass frit with a softening point not greater than 400° C. on a glass substrate to form a black layer;
a step of drying the black paste that has been applied;
a step of applying a white paste including a glass frit with a softening point not greater than 500° C. on the dried black paste to form a white layer;
a step of drying the white paste that has been applied; and
a step of exposing, developing, and sintering the black paste and white paste.

7. The method for forming a PDP front electrode according to claim 6, wherein the black paste is a black paste in which a black powder, glass frit, and photopolymerizable monomer are dispersed in a mixture of a resin, photopolymerization initiator, and solvent.

8. The method for forming a PDP front electrode according to claim 6, wherein the white paste is a white paste in which a conductive powder, glass frit, and photopolymerizable monomer are dispersed in a mixture of a resin, photopolymerization initiator, and solvent.

9. The method for forming a PDP front electrode according to claim 6, wherein the specific gravity of the glass included in the black layer and white layer is not less than 4.0.

10. The method for forming a PDP front electrode according to claim 6, wherein the black layer is formed on a glass substrate, with no transparent electrode.
